(19) United States
(12) Patent Application Publication
(10) Pub. No.: US 2026/0074831 A1
(43) Pub. Date: Mar. 12, 2026

(54) Cyclic Redundancy Check False Alarm Mitigation

(71) Applicant: Dell Products L.P., Round Rock, TX (US)

(72) Inventors: Eran Goldstein, Montreal (CA); Masoud Ebrahimi Tazeh Mahalleh, Kanata (CA); Wei Chu, Lachine (CA)

(21) Appl. No.: 18/882,382

(22) Filed: Sep. 11, 2024

(51) Int. Cl. H04L 1/00; H04L 5/00; H04W 76/28

(52) U.S. Cl. CPC H04L 1/0061; H04L 5/0051; H04L 5/006; H04W 76/28

(57) ABSTRACT

A system can receive data from a device on a channel for broadband cellular communications. The system can, based on determining that a cyclic redundancy check passes for the data, decode a payload of the data to produce a transmitted signal. The system can determine a metric of signal quality for the channel based on at least a portion of the transmitted signal that is separate from a pilot resource. The system can compare the metric of signal quality to a value specified by a signal quality criterion, to produce a signal quality result, wherein, based on the signal quality result indicating that the metric of signal quality is less than the value specified by the signal quality criterion, determine that the cyclic redundancy check passing for the data comprises a false alarm, and classify the data as a discontinuous transmission; and otherwise, determine that the data is valid.

### BACKGROUND

Broadband cellular networks can facilitate network communications with user equipment (UE).

### SUMMARY

The following presents a simplified summary of the disclosed subject matter in order to provide a basic understanding of some of the various embodiments. This summary is not an extensive overview of the various embodiments. It is intended neither to identify key or critical elements of the various embodiments nor to delineate the scope of the various embodiments. Its sole purpose is to present some concepts of the disclosure in a streamlined form as a prelude to the more detailed description that is presented later.

An example system can operate as follows. The system can receive data from a device on a channel for broadband cellular communications. The system can determine that a cyclic redundancy check passes for the data. The system can, based on the determining that the cyclic redundancy check passes for the data, decode a payload of the data to produce a transmitted signal. The system can determine a metric of signal quality for the channel based on at least a portion of the transmitted signal that is separate from a pilot resource. The system can, compare the metric of signal quality to a value specified by a signal quality criterion, to produce a signal quality result, wherein, based on the signal quality result indicating that the metric of signal quality is less than the value specified by the signal quality criterion, determine that the cyclic redundancy check passing for the data comprises a false alarm, and classify the data as a discontinuous transmission; and based on the signal quality result indicating that the metric of signal quality is greater than or equal to the value specified by the signal quality criterion, determine that the data is valid.

An example method can comprise determining, by a system comprising at least one processor, that a cyclic redundancy check passes for data received on a channel established via a broadband cellular communications network. The method can further comprise, based on the determining that the cyclic redundancy check passes for the data, decoding, by the system, a payload of the data to produce a transmitted signal. The method can further comprise determining, by the system, a metric of signal quality for the channel based on reference symbols of the transmitted signal, and at least some data symbols reconstructed from a data payload of the transmitted signal that passes for the cyclic redundancy check. The method can further comprise evaluating, by the system, the metric of signal quality with respect to a signal quality criterion, to produce a signal quality evaluation result. The method can further comprise, where the signal quality evaluation result indicates that the metric of signal quality is less than the signal quality criterion, classifying, by the system, the data as a discontinuous transmission.

An example non-transitory computer-readable medium can comprise instructions that, in response to execution, cause a system comprising a processor to perform operations. These operations can comprise, based on an error-detection code passing for data received on a channel of broadband cellular communications, decoding a payload of the data to produce a transmitted signal. These operations can further comprise determining a metric of signal quality for the channel based on at least a portion of a data payload of the transmitted signal. These operations can further comprise comparing the metric of signal quality to a threshold value determined with reference to a signal quality criterion, to produce a signal quality result. These operations can further comprise in response to the signal quality result indicating that the metric of signal quality is greater than or equal to the threshold value, determining that the data is valid.

### BRIEF DESCRIPTION OF THE DRAWINGS

Numerous embodiments, objects, and advantages of the present embodiments will be apparent upon consideration of the following detailed description, taken in conjunction with the accompanying drawings, in which like reference characters refer to like parts throughout, and in which:

FIG. 1 illustrates an example system architecture that can facilitate cyclic redundancy check (CRC) false alarm mitigation, in accordance with an embodiment of this disclosure;

FIG. 2 illustrates an example resource block (RB) physical uplink control channel (PUCCH) scenario over a resource grid, and that can facilitate CRC false alarm mitigation, in accordance with an embodiment of this disclosure;

FIG. 3 illustrates an example process flow that can facilitate CRC false alarm mitigation, in accordance with an embodiment of this disclosure;

FIG. 4 illustrates an example process flow for processing a CRC, and that can facilitate CRC false alarm mitigation, in accordance with an embodiment of this disclosure;

FIG. 5 illustrates an example process flow for signal to interference plus noise ratio (SINR) estimation, and that can facilitate CRC false alarm mitigation, in accordance with an embodiment of this disclosure;

FIG. 6 illustrates an example process flow for determining a SINR threshold, and that can facilitate CRC false alarm mitigation, in accordance with an embodiment of this disclosure;

FIG. 7 illustrates an example process flow decoding a transmitted signal according to multiple hypotheses, and that can facilitate CRC false alarm mitigation, in accordance with an embodiment of this disclosure;

FIG. 8 illustrates another example process flow that can facilitate CRC false alarm mitigation, in accordance with an embodiment of this disclosure;

FIG. 9 illustrates another example process flow that can facilitate CRC false alarm mitigation, in accordance with an embodiment of this disclosure;

FIG. 10 illustrates another example process flow that can facilitate CRC false alarm mitigation, in accordance with an embodiment of this disclosure; and

FIG. 11 illustrates an example block diagram of a computer operable to execute an embodiment of this disclosure.

### DETAILED DESCRIPTION

### Overview

A cyclic redundancy check (CRC) comprises an error-detecting code that can be used in digital networks and storage devices to detect accidental changes to digital data. Blocks of data entering these systems can have a short check value generated and attached to them, which can be based on the remainder of a polynomial division of their contents. On retrieval, the check value generation can be repeated and, in the event the check values do not match, corrective action can be taken against data corruption.

CRCs can be used in broadband cellular networks, such as 3^{rd} Generation Partnership Project (3GPP) third generation (3G), fourth generation (4G), and fifth generation (5G) technologies. It can be appreciated that the present techniques can be applied to other types of wireless communications.

A length of a CRC sequence (a number of bits) can determine a false alarm (FA) rate.

For example, a 24 bits CRC has a probability of

$$\frac{1}{{2}^{24}} \approx \frac{1}{16 E 6}$$

of producing the correct CRC (1 of 16 million) when the input is a random sequence of bits.

In some examples, that low probability can make a FA instance a rare event which does not require additional optimization. However, in some cases (e.g., in some 5G communications) a low length CRC is utilized.

In some examples of the present techniques, channel (SINR) estimation can be used as an indication for DTX.

In some examples, channel signal to interference and noise ratio (SINR) estimation can be used as an indication for discontinuous transmission (DTX; e.g., no signal was transmitted). If SINR is low enough, a CRC pass can be rejected, as there can be a high probability that no signal was transmitted.

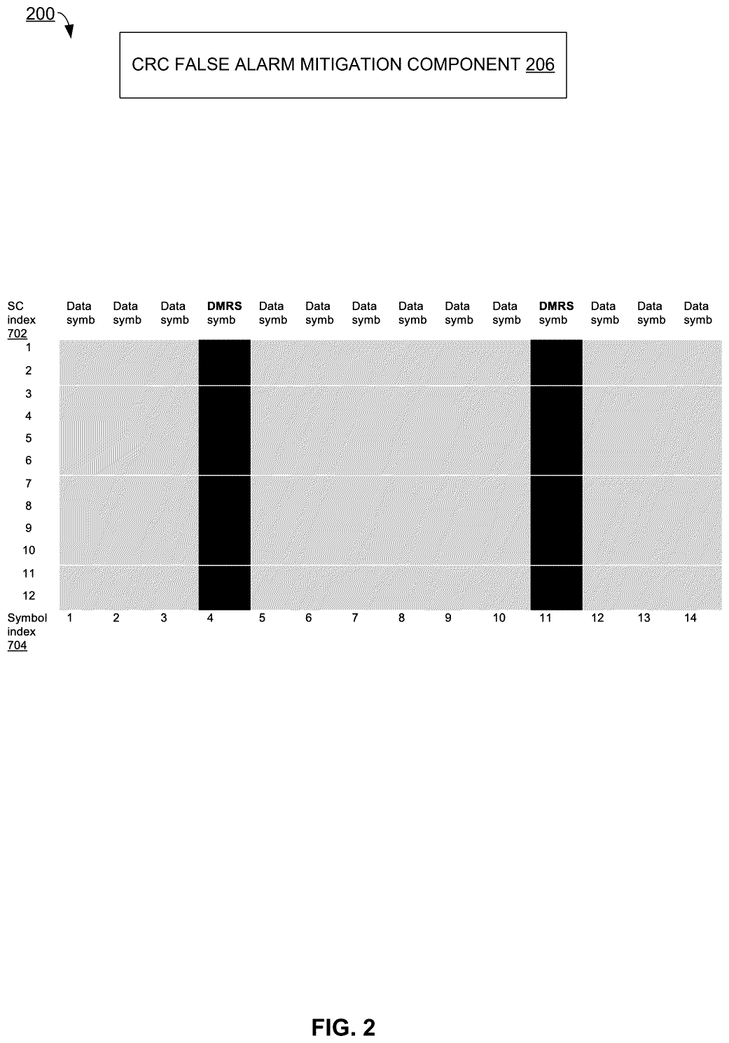

There can be a problem with this approach where there are not enough demodulation reference signal (DMRS) resources with which to accurately measure the SINR—such as when the PUCCH is transmitted over a small number of resource blocks RBs (see FIG. 2), which can be a common scenario.

Where SINR is measured over a small number of data points, it can reduce its accuracy and generally increases the measurement's standard deviation.

A high occurrence of FA or misdetection (MD) can be expected when a SINR measurement with high standard deviation is used for determining whether a signal is present. The same can be true for other channel inspection techniques, such as peak detection above noise (sometimes referred to as correlation detection), or other heuristics.

To address this problem, the receiver can implement the following steps to determine if the CRC pass is reliable or should be rejected. By following those steps, the CRC FA rate can be reduced, with a minimal increase in MD cases.
1. Following a successful CRC pass, the receiver can reconstruct the transmitted signal, based on the decoded payload.
2. By assuming the data bits are correct, the receiver can have an order of magnitude more “reference symbols” to estimate the channel and assess for SINR of it.
   a. If a signal was transmitted and the CRC is not a false alarm, the SINR estimation can be more accurate, and the standard deviation can be reduced.
   b. If no signal were transmitted, or the CRC was a FA for the decoded payload, the estimated channel can show similar characteristics as noise, and consequently a low SINR would be estimated.
3. The SINR estimated at step 3 can be compared to a threshold.
   a. SINR<threshold, then conclude DTX (no signal was detected), and CRC pass should be ignored.
   b. SINR>=threshold, then conclude CRC pass was correct.
4. The threshold can be a function of the scheduling configuration (e.g., number of RBs, number of DMRS signals, etc.).
5. In different examples, various techniques can be used to estimate signal and noise power (peak to noise, for example).
6. As the decoder uses multiple hypothesis, in the case of 3A (that is, DTX) for a given hypothesis, the next CRC pass hypothesis (if it exists) can go through steps 2 and 3. This step can be repeated for each hypothesis, and the correct payload CRC pass hypothesis can be selected.

### Example Architecture and Example

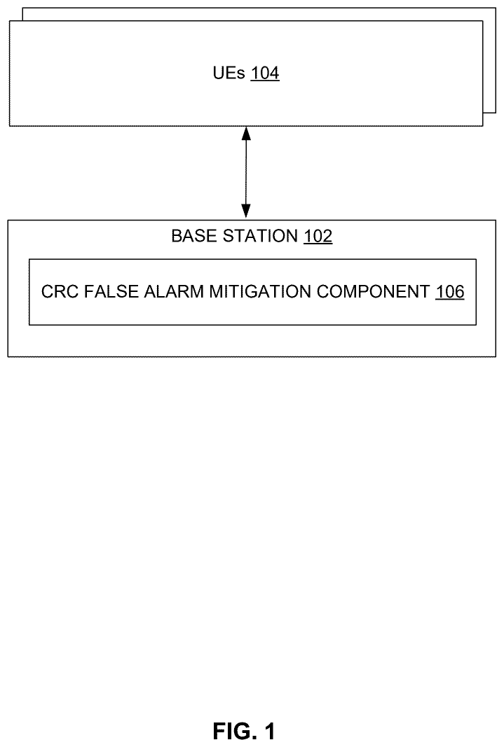

FIG. 1 illustrates an example system architecture 100 that can facilitate CRC false alarm mitigation, in accordance with an embodiment of this disclosure.

System architecture 100 comprises base station 102 and UEs 104. In turn, base station 102 comprises CRC false alarm mitigation component 106.

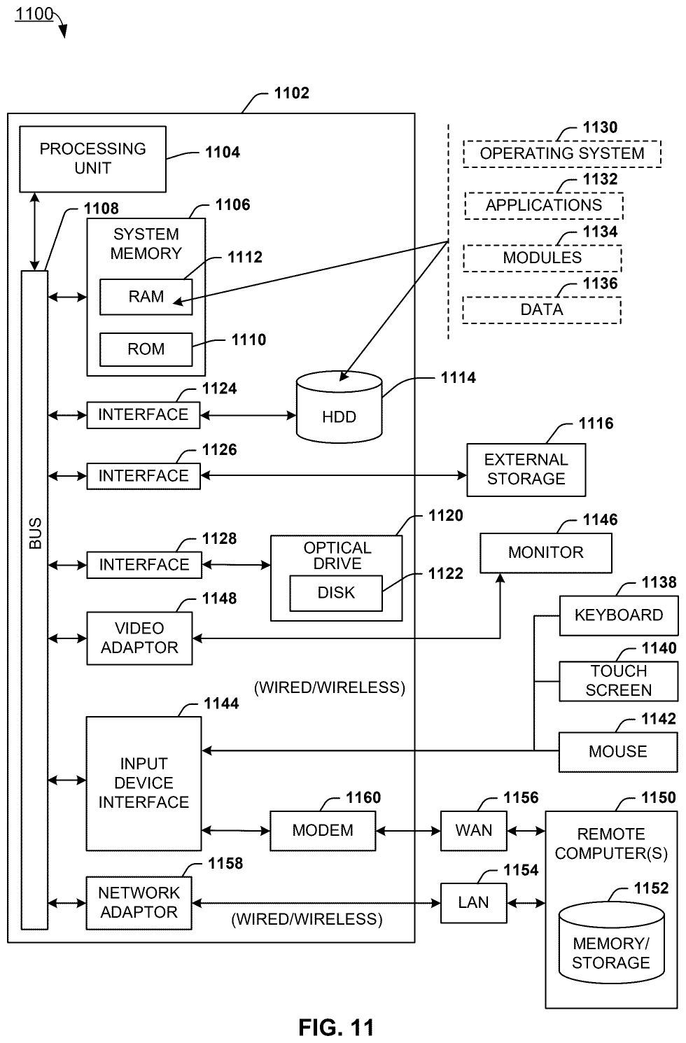

Each of base station 102 and/or UEs 104 can be implemented with part(s) of computing environment 1100 of FIG. 11.

CRC false alarm mitigation component 106 can receive transmissions from a UE of UEs 104, determine whether a CRC passes for a transmission, and where it passes, determine whether that is a false alarm or not based on whether a measure of signal quality (e.g., SINR) is sufficiently high.

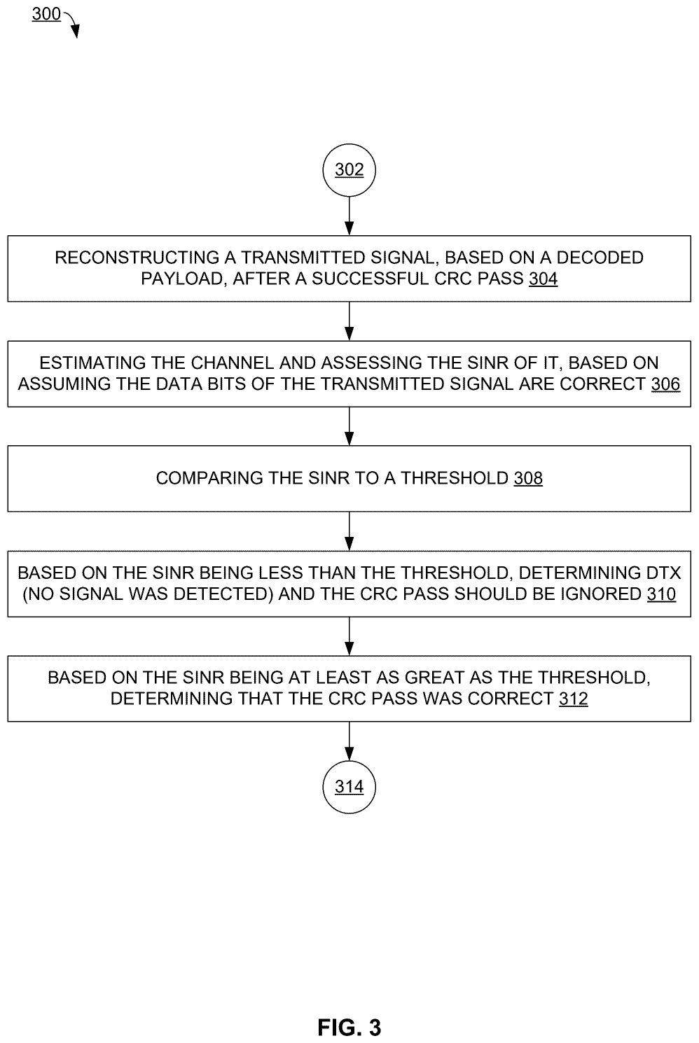

In some examples, CRC false alarm mitigation component 106 can implement part(s) of the process flows of FIGS. 3-10 to facilitate CRC false alarm mitigation.

It can be appreciated that system architecture 100 is one example system architecture for CRC false alarm mitigation, and that there can be other system architectures that facilitate CRC false alarm mitigation.

FIG. 2 illustrates an example 200 resource block (RB) physical uplink control channel (PUCCH) scenario over a resource grid, and that can facilitate CRC false alarm mitigation, in accordance with an embodiment of this disclosure. In some examples, part(s) of example 200 can be implemented by part(s) of system architecture 100 of FIG. 1 to facilitate CRC false alarm mitigation.

Example 200 comprises SC index 202, symbol index 204, and CRC false alarm mitigation component 206 (which can be similar to CRC false alarm mitigation component 106 of FIG. 1).

In some examples that comprise a 1 RB PUCCH case over a resource grid, only 24 data points are used for channel estimation. In comparison, according to the present techniques, where data is used for a channel estimation hypothesis 168 data points are available for channel estimation, which facilitates a more robust channel estimation.

### Example Process Flows

FIG. 3 illustrates an example process flow 300 that can facilitate CRC false alarm mitigation, in accordance with an embodiment of this disclosure. In some examples, one or more embodiments of process flow 300 can be implemented by system architecture 100 of FIG. 1, or computing environment 1100 of FIG. 11.

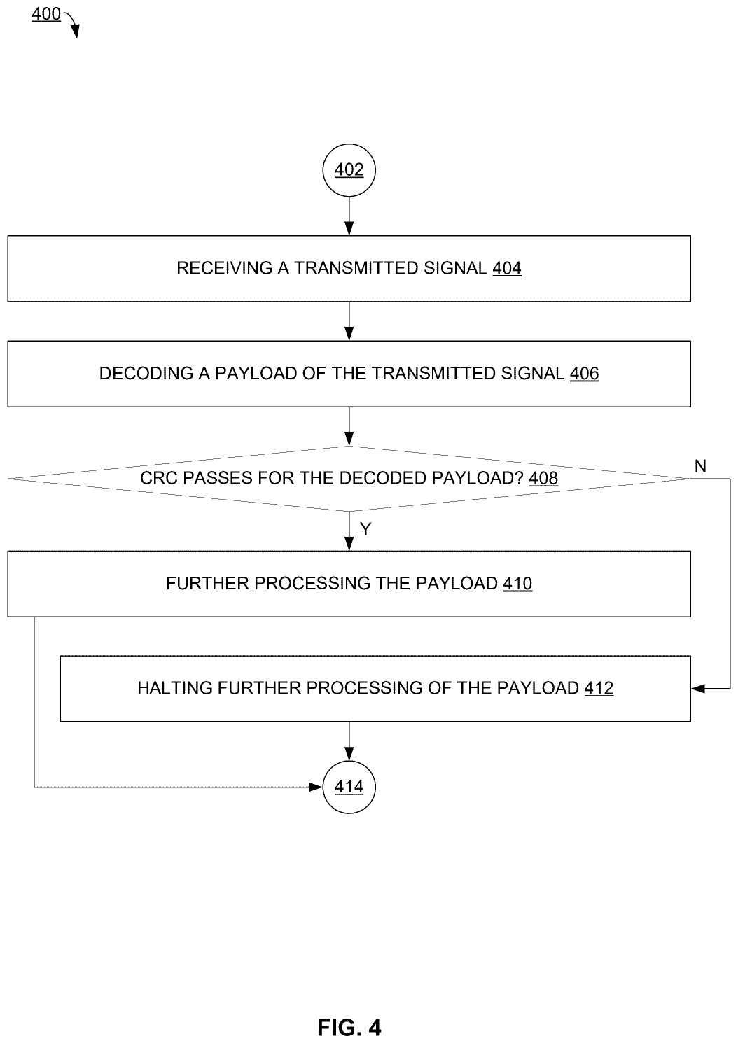

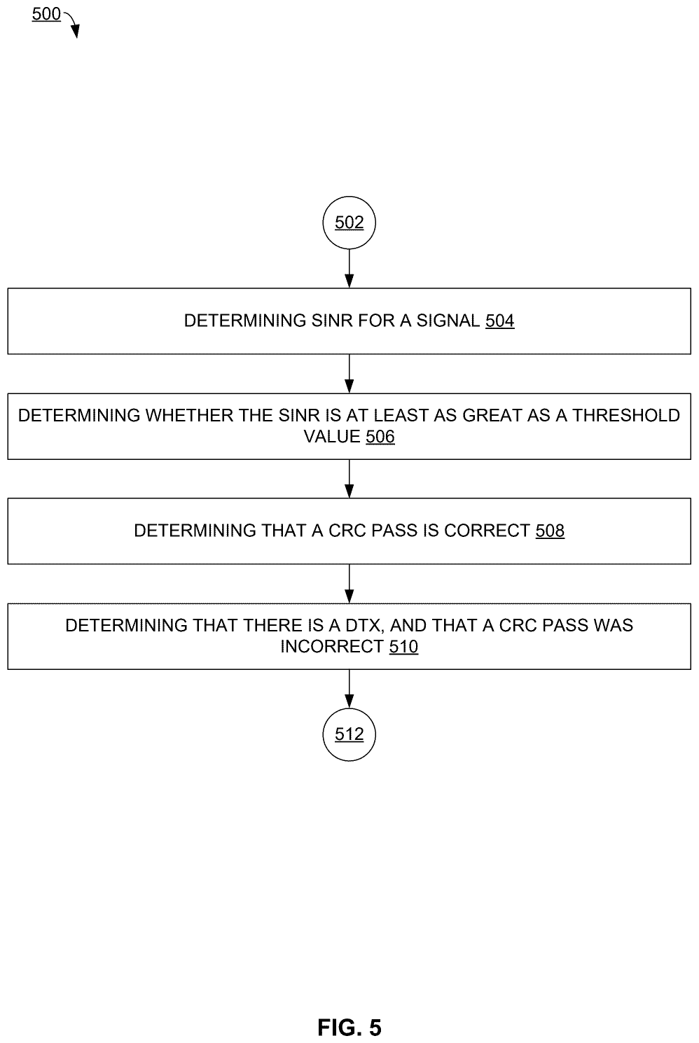

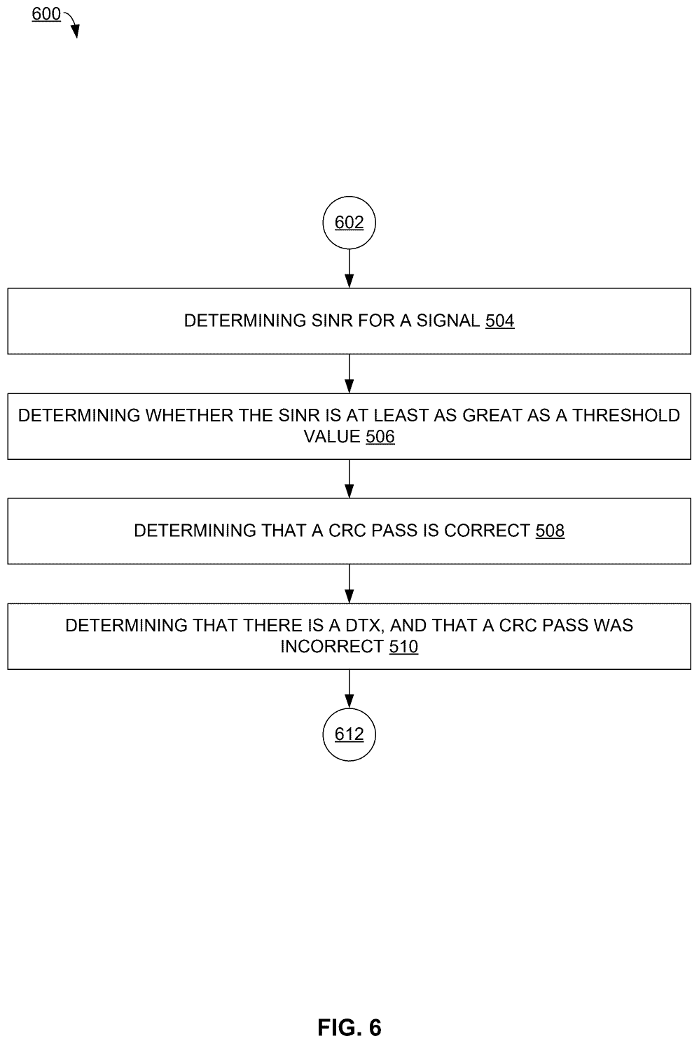

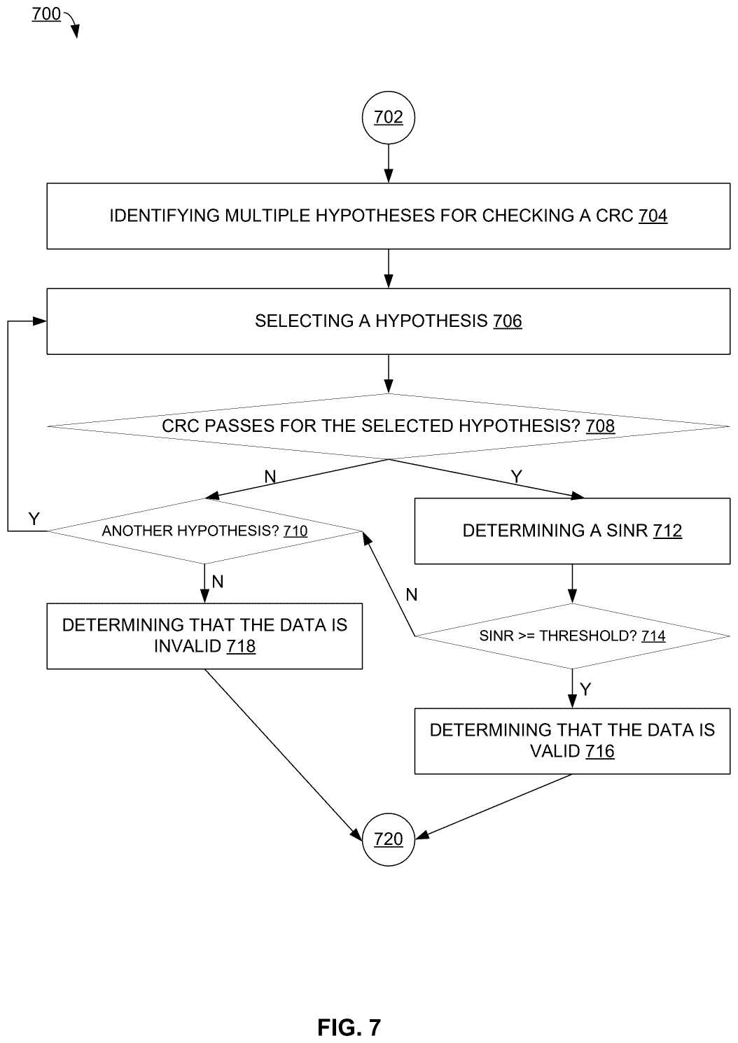

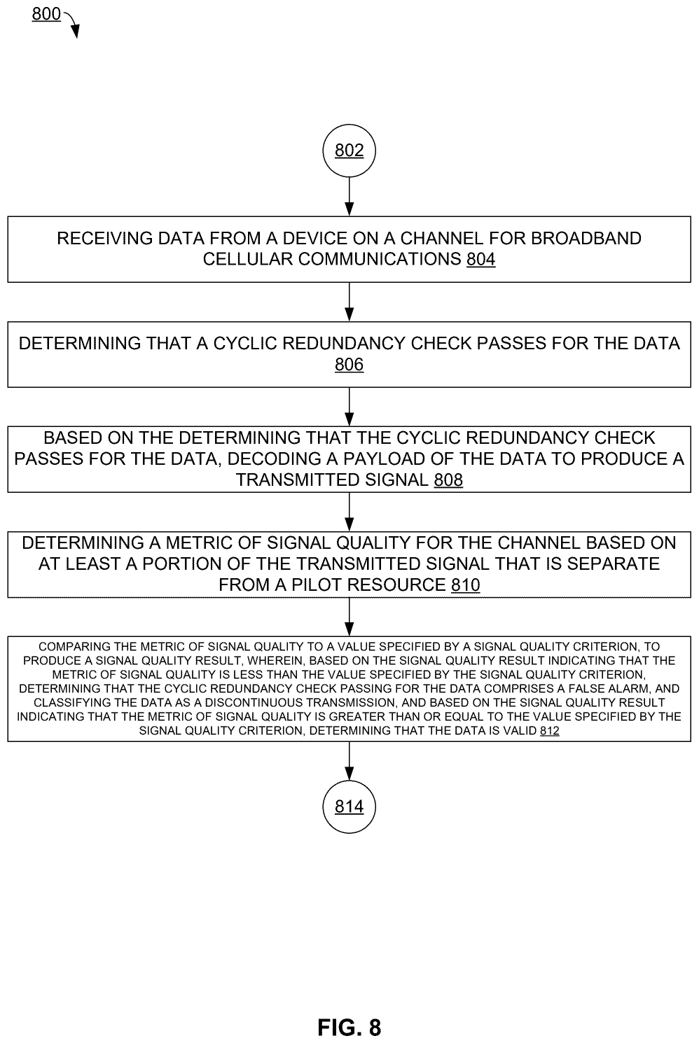

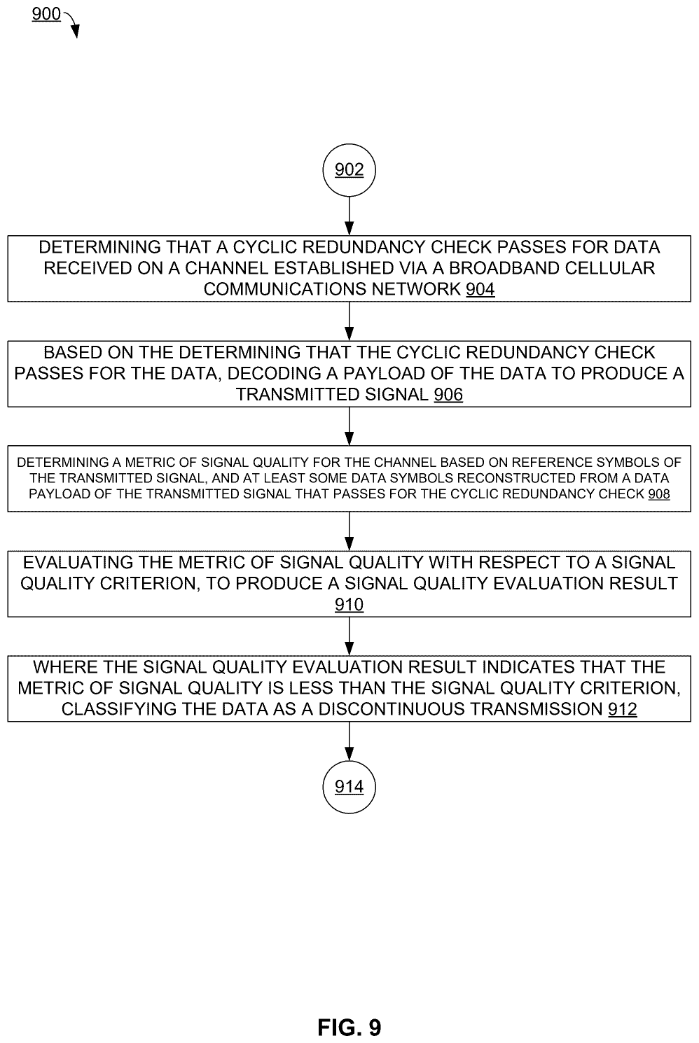

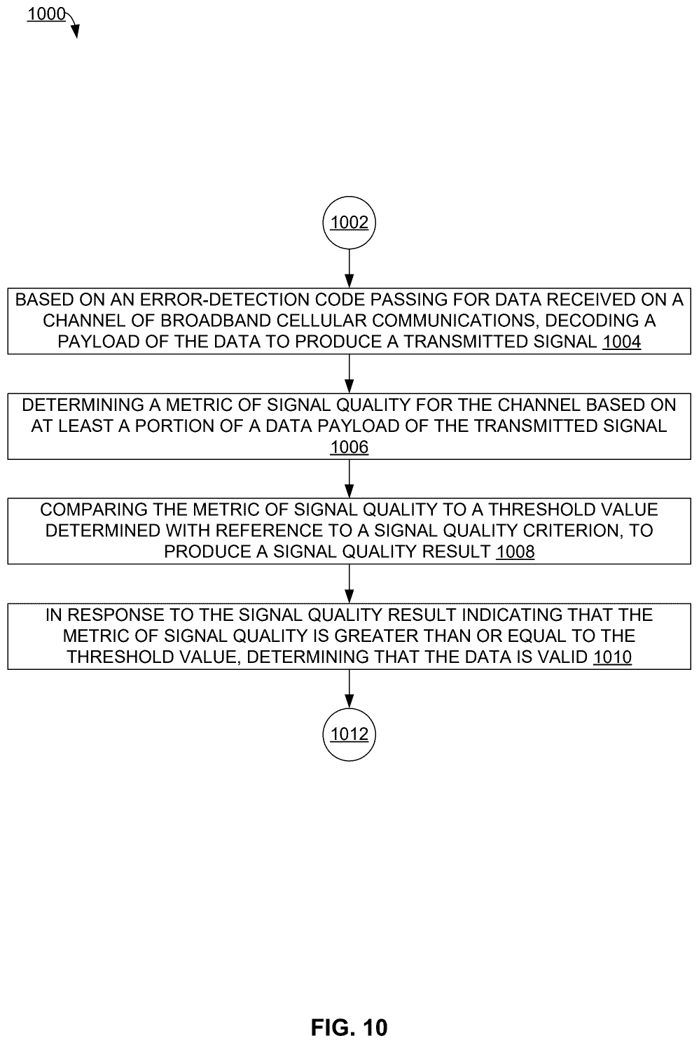

It can be appreciated that the operating procedures of process flow 300 are example operating procedures, and that there can be embodiments that implement more or fewer operating procedures than are depicted, or that implement the depicted operating procedures in a different order than as depicted. In some examples, process flow 300 can be implemented in conjunction with one or more embodiments of process flow 400 of FIG. 4, process flow 500 of FIG. 5, process flow 600 of FIG. 6, process flow 700 of FIG. 7, process flow 800 of FIG. 8, process flow 900 of FIG. 9, and/or process flow 1000 of FIG. 10.

Process flow 300 begins with 302, and moves to operation 304.

Operation 304 depicts reconstructing a transmitted signal, based on a decoded payload, after a successful CRC pass.

After operation 304, process flow 300 moves to operation 306.

Operation 306 depicts estimating the channel and assessing the SINR of it, based on assuming the data bits of the transmitted signal are correct.

After operation 306, process flow 300 moves to operation 308.

Operation 308 depicts comparing the SINR to a threshold.

After operation 308, process flow 300 moves to operation 310.

Operation 310 depicts, based on the SINR being less than the threshold, determining DTX (no signal was detected) and the CRC pass should be ignored.

After operation 310, process flow 300 moves to operation 312.

Operation 312 depicts, based on the SINR being at least as great as the threshold, determining that the CRC pass was correct. After operation 312, process flow 300 moves to 314, where process flow 300 ends.

FIG. 4 illustrates an example process flow 400 for processing a CRC, and that can facilitate CRC false alarm mitigation, in accordance with an embodiment of this disclosure. In some examples, one or more embodiments of process flow 400 can be implemented by system architecture 100 of FIG. 1, or computing environment 1100 of FIG. 11.

It can be appreciated that the operating procedures of process flow 400 are example operating procedures, and that there can be embodiments that implement more or fewer operating procedures than are depicted, or that implement the depicted operating procedures in a different order than as depicted. In some examples, process flow 400 can be implemented in conjunction with one or more embodiments of process flow 300 of FIG. 3, process flow 500 of FIG. 5, process flow 600 of FIG. 6, process flow 700 of FIG. 7, process flow 800 of FIG. 8, process flow 900 of FIG. 9, and/or process flow 1000 of FIG. 10.

Process flow 400 begins with 402, and moves to operation 404.

Operation 404 depicts receiving a transmitted signal.

After operation 404, process flow 400 moves to operation 406.

Operation 406 depicts decoding a payload of the transmitted signal.

After operation 406, process flow 400 moves to operation 408.

Operation 408 depicts determining whether a CRC passes for the decoded payload.

Where in operation 408 it is determined that the CRC passes for the decoded payload, process flow 400 moves to operation 410. Instead, where in operation 408 it is determined that the CRC fails for the decoded payload, process flow 400 moves to operation 412.

Operation 410 is reached from operation 408 where it is determined that the CRC passes for the decoded payload. Operation 410 depicts further processing the payload. After operation 410, process flow 400 moves to operation 412.

Operation 412 is reached from operation 408 where it is determined that the CRC fails for the decoded payload. Operation 412 depicts halting further processing of the payload.

After operation 412, process flow 400 moves to 414, where process flow 400 ends.

FIG. 5 illustrates an example process flow 500 for SINR estimation, and that can facilitate CRC false alarm mitigation, in accordance with an embodiment of this disclosure. In some examples, one or more embodiments of process flow 500 can be implemented by system architecture 100 of FIG. 1, or computing environment 1100 of FIG. 11.

It can be appreciated that the operating procedures of process flow 500 are example operating procedures, and that there can be embodiments that implement more or fewer operating procedures than are depicted, or that implement the depicted operating procedures in a different order than as depicted. In some examples, process flow 500 can be implemented in conjunction with one or more embodiments of process flow 300 of FIG. 3, process flow 400 of FIG. 4, process flow 600 of FIG. 6, process flow 700 of FIG. 7, process flow 800 of FIG. 8, process flow 900 of FIG. 9, and/or process flow 1000 of FIG. 10.

Process flow 500 begins with 502, and moves to operation 504.

Operation 504 depicts determining SINR for a signal.

After operation 504, process flow 500 moves to operation 506.

Operation 506 depicts determining whether the SINR is at least as great as a threshold value.

After operation 506, process flow 500 moves to operation 508.

Operation 508 is reached from operation 506 where it is determined that the SINR is at least as great as a threshold value. Operation 508 depicts determining that a CRC pass is correct.

After operation 508, process flow 500 moves to operation 510.

Operation 510 is reached from operation 506 where it is determined that the SINR is less than a threshold value. Operation 510 depicts determining that there is a DTX, and that a CRC pass was incorrect.

After operation 510, process flow 500 moves to 512, where process flow 500 ends.

FIG. 6 illustrates an example process flow 600 for determining a SINR threshold, and that can facilitate CRC false alarm mitigation, in accordance with an embodiment of this disclosure. In some examples, one or more embodiments of process flow 600 can be implemented by system architecture 100 of FIG. 1, or computing environment 1100 of FIG. 11.

It can be appreciated that the operating procedures of process flow 600 are example operating procedures, and that there can be embodiments that implement more or fewer operating procedures than are depicted, or that implement the depicted operating procedures in a different order than as depicted. In some examples, process flow 600 can be implemented in conjunction with one or more embodiments of process flow 300 of FIG. 3, process flow 400 of FIG. 4, process flow 500 of FIG. 5, process flow 700 of FIG. 7, process flow 800 of FIG. 8, process flow 900 of FIG. 9, and/or process flow 1000 of FIG. 10.

Process flow 600 begins with 602, and moves to operation 604.

Operation 604 depicts determining a number of resource blocks in a channel.

After operation 604, process flow 600 moves to operation 606.

Operation 606 depicts determining a number of demodulation reference signals in a channel.

After operation 606, process flow 600 moves to operation 608.

Operation 608 depicts determining a threshold based on the number of resource blocks and/or the number of demodulation reference signals.

After operation 608, process flow 600 moves to 610, where process flow 600 ends.

FIG. 7 illustrates an example process flow 700 for decoding a transmitted signal according to multiple hypotheses, and that can facilitate CRC false alarm mitigation, in accordance with an embodiment of this disclosure. In some examples, one or more embodiments of process flow 700 can be implemented by system architecture 100 of FIG. 1, or computing environment 1100 of FIG. 11.

It can be appreciated that the operating procedures of process flow 700 are example operating procedures, and that there can be embodiments that implement more or fewer operating procedures than are depicted, or that implement the depicted operating procedures in a different order than as depicted. In some examples, process flow 700 can be implemented in conjunction with one or more embodiments of process flow 300 of FIG. 3, process flow 400 of FIG. 4, process flow 500 of FIG. 5, process flow 600 of FIG. 6, process flow 800 of FIG. 8, process flow 900 of FIG. 9, and/or process flow 1000 of FIG. 10.

Process flow 700 begins with 702, and moves to operation 704.

Operation 704 depicts identifying multiple hypotheses for checking a CRC.

After operation 704, process flow 700 moves to operation 706.

Operation 706 is reached from operation 704, or from operation 710 where it is determined that there is another hypothesis. Operation 706 depicts selecting a hypothesis.

After operation 706, process flow 700 moves to operation 708.

Operation 708 depicts determining whether the CRC passes for the selected hypothesis.

Where in operation 708 it is determined that the CRC passes for the selected hypothesis, process flow 700 moves to operation 712. Instead, where in operation 708 it is determined that the CRC fails for the selected hypothesis, process flow 700 moves to operation 710.

Operation 710 is reached from operation 708 where it is determined that the CRC fails for the selected hypothesis, or from operation 714 where it is determined that the SINR is below a threshold value. Operation 710 depicts determining whether there is another hypothesis.

Where in operation 710 it is determined that there is another hypothesis, process flow 700 moves to operation 706.

Operation 712 is reached from operation 708 where it is determined that the CRC passes for the selected hypothesis. Operation 712 depicts determining a SINR.

After operation 712, process flow 700 moves to operation 714.

Operation 714 depicts determining whether the SINR is at least as great as a threshold.

Where in operation 714 it is determined that the SINR is at least as great as a threshold, process flow 700 moves to operation 716. Instead, where in operation 714 it is determined that the SINR is not at least as great as a threshold, process flow 700 moves to operation 710.

Operation 716 is reached from operation 714 where it is determined that the SINR is at least as great as a threshold value. Operation 716 depicts determining that the data is valid.

After operation 716, process flow 700 moves to 720, where process flow 700 ends.

Operation 718 is reached from operation 716 where it is determined that the SINR is less than a threshold value. Operation 718 depicts determining that the data is invalid.

After operation 718, process flow 700 moves to 720, where process flow 700 ends.

FIG. 8 illustrates an example process flow 800 for decoding a transmitted signal according to multiple hypotheses, and that can facilitate CRC false alarm mitigation, in accordance with an embodiment of this disclosure. In some examples, one or more embodiments of process flow 800 can be implemented by system architecture 100 of FIG. 1, or computing environment 1100 of FIG. 11.

It can be appreciated that the operating procedures of process flow 800 are example operating procedures, and that there can be embodiments that implement more or fewer operating procedures than are depicted, or that implement the depicted operating procedures in a different order than as depicted. In some examples, process flow 800 can be implemented in conjunction with one or more embodiments of process flow 300 of FIG. 3, process flow 400 of FIG. 4, process flow 500 of FIG. 5, process flow 600 of FIG. 6, process flow 700 of FIG. 7, process flow 900 of FIG. 9, and/or process flow 1000 of FIG. 10.

Process flow 800 begins with 802, and moves to operation 804.

Operation 804 depicts receiving data from a device on a channel for broadband cellular communications. In some examples, operation 804 can be implemented in a similar manner as operation 304 of FIG. 3.

After operation 804, process flow 800 moves to operation 806.

Operation 806 depicts determining that a cyclic redundancy check passes for the data. In some examples, operation 806 can be implemented in a similar manner as operation 304 of FIG. 3.

After operation 806, process flow 800 moves to operation 808.

Operation 808 depicts based on the determining that the cyclic redundancy check passes for the data, decoding a payload of the data to produce a transmitted signal. In some examples, operation 808 can be implemented in a similar manner as operation 304 of FIG. 3.

After operation 808, process flow 800 moves to operation 810.

Operation 810 depicts determining a metric of signal quality for the channel based on at least a portion of the transmitted signal that is separate from a pilot resource. In some examples, operation 810 can be implemented in a similar manner as operation 306 of FIG. 3.

After operation 810, process flow 800 moves to operation 812.

Operation 812 depicts comparing the metric of signal quality to a value specified by a signal quality criterion, to produce a signal quality result, wherein, based on the signal quality result indicating that the metric of signal quality is less than the value specified by the signal quality criterion, determining that the cyclic redundancy check passing for the data comprises a false alarm, and classifying the data as a discontinuous transmission, and based on the signal quality result indicating that the metric of signal quality is greater than or equal to the value specified by the signal quality criterion, determining that the data is valid. In some examples, operation 812 can be implemented in a similar manner as operations 310-312 of FIG. 3.

In some examples, the signal quality criterion is based on a scheduling configuration. In some examples, the scheduling configuration comprises a specified number of resource blocks. In some examples, the scheduling configuration comprises a specified number of demodulation reference signals. That is, a signal quality criterion can be a function of a scheduling configuration (e.g., a number of RBs and/or a number of DMRS signals).

in some examples, the metric of signal quality comprises a signal to noise plus interference ratio or a peak signal to noise metric. That is, different techniques for estimating signal and noise power can be used, such as SINR and/or peak to noise.

In some examples, the determining that the cyclic redundancy check passes for the data comprises determining that the cyclic redundancy check passes for the data based on satisfaction of a hypothesis of a group of hypotheses usable to test the cyclic redundancy check. That is, such as with polar codes, there can be multiple hypotheses (or techniques) for determining whether a CRC passes for data, and these multiple hypotheses can be used together.

In some examples, the determining that the cyclic redundancy check passes for the data comprises, based on determining that the cyclic redundancy check fails for the data based on a first hypothesis of a group of hypotheses usable to test the cyclic redundancy check, determining that the cyclic redundancy check passes for the data based on satisfaction of a second hypothesis of the group of hypotheses. That is, when using multiple hypotheses, it can be that one hypothesis is checked, and if it fails, another hypothesis is checked (of one exists). A CRC pass according to any of the hypotheses can indicate a CRC pass for the data.

In some examples, the metric of signal quality is a first metric of signal quality, and the determining that the cyclic redundancy check fails for the data based on the first hypothesis of the group of hypotheses comprises determining that a second metric of signal quality that corresponds to the first hypothesis is less than the value specified by the signal quality criterion. That is, a failed hypothesis can mean that its corresponding SINR (or measure of signal quality) is below a threshold.

In some examples, the cyclic redundancy check is determined to have failed where the cyclic redundancy check fails with each hypothesis of a group of hypotheses usable to test the cyclic redundancy check. That is, a CRC can fail where it fails under each hypothesis of a group of hypotheses (compared to failing under any of the hypotheses).

After operation 812, process flow 800 moves to 814, where process flow 800 ends.

FIG. 9 illustrates an example process flow 900 for decoding a transmitted signal according to multiple hypotheses, and that can facilitate CRC false alarm mitigation, in accordance with an embodiment of this disclosure. In some examples, one or more embodiments of process flow 900 can be implemented by system architecture 100 of FIG. 1, or computing environment 1100 of FIG. 11.

It can be appreciated that the operating procedures of process flow 900 are example operating procedures, and that there can be embodiments that implement more or fewer operating procedures than are depicted, or that implement the depicted operating procedures in a different order than as depicted. In some examples, process flow 900 can be implemented in conjunction with one or more embodiments of process flow 300 of FIG. 3, process flow 400 of FIG. 4, process flow 500 of FIG. 5, process flow 600 of FIG. 6, process flow 700 of FIG. 7, process flow 800 of FIG. 8, and/or process flow 1000 of FIG. 10.

Process flow 900 begins with 902, and moves to operation 904.

Operation 904 depicts determining that a cyclic redundancy check passes for data received on a channel established via a broadband cellular communications network. In some examples, operation 904 can be implemented in a similar manner as operation 804 of FIG. 8.

In some examples, the cyclic redundancy check comprises error-detecting data for the data.

After operation 904, process flow 900 moves to operation 906.

Operation 906 depicts, based on the determining that the cyclic redundancy check passes for the data, decoding a payload of the data to produce a transmitted signal. In some examples, operation 906 can be implemented in a similar manner as operation 806 of FIG. 8.

After operation 906, process flow 900 moves to operation 908.

Operation 908 depicts determining a metric of signal quality for the channel based on reference symbols of the transmitted signal, and at least some data symbols reconstructed from a data payload of the transmitted signal that passes for the cyclic redundancy check. In some examples, operation 908 can be implemented in a similar manner as operation 808 of FIG. 8.

In some examples, determining the metric of signal quality for the channel is based on at least a portion of the transmitted signal that is separate from a demodulation reference signal. That is, in some examples, by assuming the data bits are correct, the receiver can have an order of magnitude more reference symbols with which to estimate the channel and assess its SINR.

After operation 908, process flow 900 moves to operation 910.

Operation 910 depicts evaluating the metric of signal quality with respect to a signal quality criterion, to produce a signal quality evaluation result. In some examples, operation 910 can be implemented in a similar manner as operation 810 of FIG. 8.

After operation 910, process flow 900 moves to operation 912.

Operation 912 depicts, where the signal quality evaluation result indicates that the metric of signal quality is less than the signal quality criterion, classifying the data as a discontinuous transmission. In some examples, operation 912 can be implemented in a similar manner as operation 812 of FIG. 8.

In some examples, operation 912 comprises, where the signal quality evaluation result indicates that the metric of signal quality is less than the signal quality criterion, disregarding that the cyclic redundancy check passes for the data. That is, the CRC pass can be ignored when the SINR (or another signal metric) is low.

In some examples, operation 912 comprises, where the signal quality evaluation result indicates that the metric of signal quality is greater than or equal to the signal quality criterion, determining that the data is valid. That is, where the SINR (or other signal metric) is high, that can indicate that the data is valid.

After operation 912, process flow 900 moves to 914, where process flow 900 ends.

FIG. 10 illustrates an example process flow 1000 for decoding a transmitted signal according to multiple hypotheses, and that can facilitate CRC false alarm mitigation, in accordance with an embodiment of this disclosure. In some examples, one or more embodiments of process flow 1000 can be implemented by system architecture 100 of FIG. 1, or computing environment 1100 of FIG. 11.

It can be appreciated that the operating procedures of process flow 1000 are example operating procedures, and that there can be embodiments that implement more or fewer operating procedures than are depicted, or that implement the depicted operating procedures in a different order than as depicted. In some examples, process flow 1000 can be implemented in conjunction with one or more embodiments of process flow 300 of FIG. 3, process flow 400 of FIG. 4, process flow 500 of FIG. 5, process flow 600 of FIG. 6, process flow 700 of FIG. 7, process flow 800 of FIG. 8, and/or process flow 900 of FIG. 9.

Process flow 1000 begins with 1002, and moves to operation 1004.

Operation 1004 depicts, based on an error-detection code passing for data received on a channel of broadband cellular communications, decoding a payload of the data to produce a transmitted signal. In some examples, operation 1004 can be implemented in a similar manner as operations 804-806 of FIG. 8.

In some examples, a system that implements process flow 800 comprises a base station that facilitates the broadband cellular communications.

After operation 1004, process flow 1000 moves to operation 1006.

Operation 1006 depicts determining a metric of signal quality for the channel based on at least a portion of a data payload of the transmitted signal. In some examples, operation 1006 can be implemented in a similar manner as operation 808 of FIG. 8.

After operation 1006, process flow 1000 moves to operation 1008.

Operation 1008 depicts comparing the metric of signal quality to a threshold value determined with reference to a signal quality criterion, to produce a signal quality result. In some examples, operation 1008 can be implemented in a similar manner as operation 810 of FIG. 8.

In some examples, the signal quality criterion is specified as a function of a scheduling configuration. In some examples, the scheduling configuration specifies a number of resource blocks or a number of demodulation reference signals, and wherein the signal quality criterion is specified as a function of the number of resource blocks or a number of demodulation reference signals.

After operation 1008, process flow 1000 moves to operation 1010.

Operation 1010 depicts, in response to the signal quality result indicating that the metric of signal quality is greater than or equal to the threshold value, determining that the data is valid. In some examples, operation 1010 can be implemented in a similar manner as operation 812 of FIG. 8.

In some examples, operation 1010 comprises, in response to the signal quality result indicating that the metric of signal quality is less than the threshold value, classifying the data as a discontinuous transmission.

In some examples, operation 1010 comprises, in response to the signal quality result indicating that the metric of signal quality is less than the threshold value, determining that the error-detection code passing was mis-detected.

After operation 1010, process flow 1000 moves to 1012, where process flow 1000 ends.

### Example Operating Environment

In order to provide additional context for various embodiments described herein, FIG. 11 and the following discussion are intended to provide a brief, general description of a suitable computing environment 1100 in which the various embodiments of the embodiment described herein can be implemented.

For example, parts of computing environment 1100 can be used to implement one or more embodiments of base station 102 and/or UEs 104 of FIG. 1.

In some examples, computing environment 1100 can implement one or more embodiments of the process flows of FIGS. 3-10 to facilitate CRC false alarm mitigation.

While the embodiments have been described above in the general context of computer-executable instructions that can run on one or more computers, those skilled in the art will recognize that the embodiments can be also implemented in combination with other program modules and/or as a combination of hardware and software.

Generally, program modules include routines, programs, components, data structures, etc., that perform particular tasks or implement particular abstract data types. Moreover, those skilled in the art will appreciate that the various methods can be practiced with other computer system configurations, including single-processor or multiprocessor computer systems, minicomputers, mainframe computers, Internet of Things (IOT) devices, distributed computing systems, as well as personal computers, hand-held computing devices, microprocessor-based or programmable consumer electronics, and the like, each of which can be operatively coupled to one or more associated devices.

The illustrated embodiments of the embodiments herein can be also practiced in distributed computing environments where certain tasks are performed by remote processing devices that are linked through a communications network. In a distributed computing environment, program modules can be located in both local and remote memory storage devices.

Computing devices typically include a variety of media, which can include computer-readable storage media, machine-readable storage media, and/or communications media, which two terms are used herein differently from one another as follows. Computer-readable storage media or machine-readable storage media can be any available storage media that can be accessed by the computer and includes both volatile and nonvolatile media, removable and non-removable media. By way of example, and not limitation, computer-readable storage media or machine-readable storage media can be implemented in connection with any method or technology for storage of information such as computer-readable or machine-readable instructions, program modules, structured data or unstructured data.

Computer-readable storage media can include, but are not limited to, random access memory (RAM), read only memory (ROM), electrically erasable programmable read only memory (EEPROM), flash memory or other memory technology, compact disk read only memory (CD-ROM), digital versatile disk (DVD), Blu-ray disc (BD) or other optical disk storage, magnetic cassettes, magnetic tape, magnetic disk storage or other magnetic storage devices, solid state drives or other solid state storage devices, or other tangible and/or non-transitory media which can be used to store desired information. In this regard, the terms “tangible” or “non-transitory” herein as applied to storage, memory or computer-readable media, are to be understood to exclude only propagating transitory signals per se as modifiers and do not relinquish rights to all standard storage, memory or computer-readable media that are not only propagating transitory signals per se.

Computer-readable storage media can be accessed by one or more local or remote computing devices, e.g., via access requests, queries or other data retrieval protocols, for a variety of operations with respect to the information stored by the medium.

Communications media typically embody computer-readable instructions, data structures, program modules or other structured or unstructured data in a data signal such as a modulated data signal, e.g., a carrier wave or other transport mechanism, and includes any information delivery or transport media. The term “modulated data signal” or signals refers to a signal that has one or more of its characteristics set or changed in such a manner as to encode information in one or more signals. By way of example, and not limitation, communication media include wired media, such as a wired network or direct-wired connection, and wireless media such as acoustic, RF, infrared and other wireless media.

With reference again to FIG. 11, the example environment 1100 for implementing various embodiments described herein includes a computer 1102, the computer 1102 including a processing unit 1104, a system memory 1106 and a system bus 1108. The system bus 1108 couples system components including, but not limited to, the system memory 1106 to the processing unit 1104. The processing unit 1104 can be any of various commercially available processors. Dual microprocessors and other multi-processor architectures can also be employed as the processing unit 1104.

The system bus 1108 can be any of several types of bus structure that can further interconnect to a memory bus (with or without a memory controller), a peripheral bus, and a local bus using any of a variety of commercially available bus architectures. The system memory 1106 includes ROM 1110 and RAM 1112. A basic input/output system (BIOS) can be stored in a nonvolatile storage such as ROM, erasable programmable read only memory (EPROM), EEPROM, which BIOS contains the basic routines that help to transfer information between elements within the computer 1102, such as during startup. The RAM 1112 can also include a high-speed RAM such as static RAM for caching data.

The computer 1102 further includes an internal hard disk drive (HDD) 1114 (e.g., EIDE, SATA), one or more external storage devices 1116 (e.g., a magnetic floppy disk drive (FDD) 1116, a memory stick or flash drive reader, a memory card reader, etc.) and an optical disk drive 1120 (e.g., which can read or write from a CD-ROM disc, a DVD, a BD, etc.). While the internal HDD 1114 is illustrated as located within the computer 1102, the internal HDD 1114 can also be configured for external use in a suitable chassis (not shown). Additionally, while not shown in environment 1100, a solid state drive (SSD) could be used in addition to, or in place of, an HDD 1114. The HDD 1114, external storage device(s) 1116 and optical disk drive 1120 can be connected to the system bus 1108 by an HDD interface 1124, an external storage interface 1126 and an optical drive interface 1128, respectively. The interface 1124 for external drive implementations can include at least one or both of Universal Serial Bus (USB) and Institute of Electrical and Electronics Engineers (IEEE) 1394 interface technologies. Other external drive connection technologies are within contemplation of the embodiments described herein.

The drives and their associated computer-readable storage media provide nonvolatile storage of data, data structures, computer-executable instructions, and so forth. For the computer 1102, the drives and storage media accommodate the storage of any data in a suitable digital format. Although the description of computer-readable storage media above refers to respective types of storage devices, it should be appreciated by those skilled in the art that other types of storage media which are readable by a computer, whether presently existing or developed in the future, could also be used in the example operating environment, and further, that any such storage media can contain computer-executable instructions for performing the methods described herein.

A number of program modules can be stored in the drives and RAM 1112, including an operating system 1130, one or more application programs 1132, other program modules 1134 and program data 1136. All or portions of the operating system, applications, modules, and/or data can also be cached in the RAM 1112. The systems and methods described herein can be implemented utilizing various commercially available operating systems or combinations of operating systems.

Computer 1102 can optionally comprise emulation technologies. For example, a hypervisor (not shown) or other intermediary can emulate a hardware environment for operating system 1130, and the emulated hardware can optionally be different from the hardware illustrated in FIG. 11. In such an embodiment, operating system 1130 can comprise one virtual machine (VM) of multiple VMs hosted at computer 1102. Furthermore, operating system 1130 can provide runtime environments, such as the Java runtime environment or the .NET framework, for applications 1132. Runtime environments are consistent execution environments that allow applications 1132 to run on any operating system that includes the runtime environment. Similarly, operating system 1130 can support containers, and applications 1132 can be in the form of containers, which are lightweight, standalone, executable packages of software that include, e.g., code, runtime, system tools, system libraries and settings for an application.

Further, computer 1102 can be enabled with a security module, such as a trusted processing module (TPM). For instance, with a TPM, boot components hash next in time boot components, and wait for a match of results to secured values, before loading a next boot component. This process can take place at any layer in the code execution stack of computer 1102, e.g., applied at the application execution level or at the operating system (OS) kernel level, thereby enabling security at any level of code execution.

A user can enter commands and information into the computer 1102 through one or more wired/wireless input devices, e.g., a keyboard 1138, a touch screen 1140, and a pointing device, such as a mouse 1142. Other input devices (not shown) can include a microphone, an infrared (IR) remote control, a radio frequency (RF) remote control, or other remote control, a joystick, a virtual reality controller and/or virtual reality headset, a game pad, a stylus pen, an image input device, e.g., camera(s), a gesture sensor input device, a vision movement sensor input device, an emotion or facial detection device, a biometric input device, e.g., fingerprint or iris scanner, or the like. These and other input devices are often connected to the processing unit 1104 through an input device interface 1144 that can be coupled to the system bus 1108, but can be connected by other interfaces, such as a parallel port, an IEEE 1394 serial port, a game port, a USB port, an IR interface, a BLUETOOTH® interface, etc.

A monitor 1146 or other type of display device can be also connected to the system bus 1108 via an interface, such as a video adapter 1148. In addition to the monitor 1146, a computer typically includes other peripheral output devices (not shown), such as speakers, printers, etc.

The computer 1102 can operate in a networked environment using logical connections via wired and/or wireless communications to one or more remote computers, such as a remote computer(s) 1150. The remote computer(s) 1150 can be a workstation, a server computer, a router, a personal computer, portable computer, microprocessor-based entertainment appliance, a peer device or other common network node, and typically includes many or all of the elements described relative to the computer 1102, although, for purposes of brevity, only a memory/storage device 1152 is illustrated. The logical connections depicted include wired/wireless connectivity to a local area network (LAN) 1154 and/or larger networks, e.g., a wide area network (WAN) 1156. Such LAN and WAN networking environments are commonplace in offices and companies, and facilitate enterprise-wide computer networks, such as intranets, all of which can connect to a global communications network, e.g., the Internet.

When used in a LAN networking environment, the computer 1102 can be connected to the local network 1154 through a wired and/or wireless communication network interface or adapter 1158. The adapter 1158 can facilitate wired or wireless communication to the LAN 1154, which can also include a wireless access point (AP) disposed thereon for communicating with the adapter 1158 in a wireless mode.

When used in a WAN networking environment, the computer 1102 can include a modem 1160 or can be connected to a communications server on the WAN 1156 via other means for establishing communications over the WAN 1156, such as by way of the Internet. The modem 1160, which can be internal or external and a wired or wireless device, can be connected to the system bus 1108 via the input device interface 1144. In a networked environment, program modules depicted relative to the computer 1102 or portions thereof, can be stored in the remote memory/storage device 1152. It will be appreciated that the network connections shown are examples, and other means of establishing a communications link between the computers can be used.

When used in either a LAN or WAN networking environment, the computer 1102 can access cloud storage systems or other network-based storage systems in addition to, or in place of, external storage devices 1116 as described above. Generally, a connection between the computer 1102 and a cloud storage system can be established over a LAN 1154 or WAN 1156 e.g., by the adapter 1158 or modem 1160, respectively. Upon connecting the computer 1102 to an associated cloud storage system, the external storage interface 1126 can, with the aid of the adapter 1158 and/or modem 1160, manage storage provided by the cloud storage system as it would other types of external storage. For instance, the external storage interface 1116 can be configured to provide access to cloud storage sources as if those sources were physically connected to the computer 1102.

The computer 1102 can be operable to communicate with any wireless devices or entities operatively disposed in wireless communication, e.g., a printer, scanner, desktop and/or portable computer, portable data assistant, communications satellite, any piece of equipment or location associated with a wirelessly detectable tag (e.g., a kiosk, news stand, store shelf, etc.), and telephone. This can include Wireless Fidelity (Wi-Fi) and BLUETOOTH® wireless technologies. Thus, the communication can be a predefined structure as with a conventional network or simply an ad hoc communication between at least two devices.

### CONCLUSION

As it employed in the subject specification, the term “processor” can refer to substantially any computing processing unit or device comprising, but not limited to comprising, single-core processors; single-processors with software multithread execution capability; multi-core processors; multi-core processors with software multithread execution capability; multi-core processors with hardware multithread technology; parallel platforms; and parallel platforms with distributed shared memory in a single machine or multiple machines. Additionally, a processor can refer to an integrated circuit, a state machine, an application specific integrated circuit (ASIC), a digital signal processor (DSP), a programmable gate array (PGA) including a field programmable gate array (FPGA), a programmable logic controller (PLC), a complex programmable logic device (CPLD), a discrete gate or transistor logic, discrete hardware components, or any combination thereof designed to perform the functions described herein. Processors can exploit nano-scale architectures such as, but not limited to, molecular and quantum-dot based transistors, switches and gates, in order to optimize space usage or enhance performance of user equipment. A processor may also be implemented as a combination of computing processing units. One or more processors can be utilized in supporting a virtualized computing environment. The virtualized computing environment may support one or more virtual machines representing computers, servers, or other computing devices. In such virtualized virtual machines, components such as processors and storage devices may be virtualized or logically represented. For instance, when a processor executes instructions to perform “operations”, this could include the processor performing the operations directly and/or facilitating, directing, or cooperating with another device or component to perform the operations.

In the subject specification, terms such as “datastore,” data storage,” “database,” “cache,” and substantially any other information storage component relevant to operation and functionality of a component, refer to “memory components,” or entities embodied in a “memory” or components comprising the memory. It will be appreciated that the memory components, or computer-readable storage media, described herein can be either volatile memory or nonvolatile storage, or can include both volatile and nonvolatile storage. By way of illustration, and not limitation, nonvolatile storage can include ROM, programmable ROM (PROM), EPROM, EEPROM, or flash memory. Volatile memory can include RAM, which acts as external cache memory. By way of illustration and not limitation, RAM can be available in many forms such as synchronous RAM (SRAM), dynamic RAM (DRAM), synchronous DRAM (SDRAM), double data rate SDRAM (DDR SDRAM), enhanced SDRAM (ESDRAM), Synchlink DRAM (SLDRAM), and direct Rambus RAM (DRRAM). Additionally, the disclosed memory components of systems or methods herein are intended to comprise, without being limited to comprising, these and any other suitable types of memory.

The illustrated embodiments of the disclosure can be practiced in distributed computing environments where certain tasks are performed by remote processing devices that are linked through a communications network. In a distributed computing environment, program modules can be located in both local and remote memory storage devices.

The systems and processes described above can be embodied within hardware, such as a single integrated circuit (IC) chip, multiple ICs, an ASIC, or the like. Further, the order in which some or all of the process blocks appear in each process should not be deemed limiting. Rather, it should be understood that some of the process blocks can be executed in a variety of orders that are not all of which may be explicitly illustrated herein.

As used in this application, the terms “component,” “module,” “system,” “interface,” “cluster,” “server,” “node,” or the like are generally intended to refer to a computer-related entity, either hardware, a combination of hardware and software, software, or software in execution or an entity related to an operational machine with one or more specific functionalities. For example, a component can be, but is not limited to being, a process running on a processor, a processor, an object, an executable, a thread of execution, computer-executable instruction(s), a program, and/or a computer. By way of illustration, both an application running on a controller and the controller can be a component. One or more components may reside within a process and/or thread of execution and a component may be localized on one computer and/or distributed between two or more computers. As another example, an interface can include input/output (I/O) components as well as associated processor, application, and/or application programming interface (API) components.

Further, the various embodiments can be implemented as a method, apparatus, or article of manufacture using standard programming and/or engineering techniques to produce software, firmware, hardware, or any combination thereof to control a computer to implement one or more embodiments of the disclosed subject matter. An article of manufacture can encompass a computer program accessible from any computer-readable device or computer-readable storage/communications media. For example, computer readable storage media can include but are not limited to magnetic storage devices (e.g., hard disk, floppy disk, magnetic strips . . . ), optical discs (e.g., CD, DVD . . . ), smart cards, and flash memory devices (e.g., card, stick, key drive . . . ). Of course, those skilled in the art will recognize many modifications can be made to this configuration without departing from the scope or spirit of the various embodiments.

In addition, the word “example” or “exemplary” is used herein to mean serving as an example, instance, or illustration. Any embodiment or design described herein as “exemplary” is not necessarily to be construed as preferred or advantageous over other embodiments or designs. Rather, use of the word exemplary is intended to present concepts in a concrete fashion. As used in this application, the term “or” is intended to mean an inclusive “or” rather than an exclusive “or.” That is, unless specified otherwise, or clear from context, “X employs A or B” is intended to mean any of the natural inclusive permutations. That is, if X employs A; X employs B; or X employs both A and B, then “X employs A or B” is satisfied under any of the foregoing instances. In addition, the articles “a” and “an” as used in this application and the appended claims should generally be construed to mean “one or more” unless specified otherwise or clear from context to be directed to a singular form.

What has been described above includes examples of the present specification. It is, of course, not possible to describe every conceivable combination of components or methods for purposes of describing the present specification, but one of ordinary skill in the art may recognize that many further combinations and permutations of the present specification are possible. Accordingly, the present specification is intended to embrace all such alterations, modifications and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

What is claimed is:

1. A system, comprising:
at least one processor; and
at least one memory that stores executable instructions that, when executed by the at least one processor, facilitate performance of operations, comprising:
receiving data from a device on a channel for broadband cellular communications;
determining that a cyclic redundancy check passes for the data;
based on the determining that the cyclic redundancy check passes for the data, decoding a payload of the data to produce a transmitted signal;
determining a metric of signal quality for the channel based on at least a portion of the transmitted signal that is separate from a pilot resource; and
comparing the metric of signal quality to a value specified by a signal quality criterion, to produce a signal quality result, wherein,
based on the signal quality result indicating that the metric of signal quality is less than the value specified by the signal quality criterion,
determining that the cyclic redundancy check passing for the data comprises a false alarm, and
classifying the data as a discontinuous transmission, and
based on the signal quality result indicating that the metric of signal quality is greater than or equal to the value specified by the signal quality criterion, determining that the data is valid.

2. The system of claim 1, wherein the signal quality criterion is based on a scheduling configuration.

3. The system of claim 2, wherein the scheduling configuration comprises a specified number of resource blocks.

4. The system of claim 2, wherein the scheduling configuration comprises a specified number of demodulation reference signals.

5. The system of claim 1, wherein the metric of signal quality comprises a signal to noise plus interference ratio or a peak signal to noise metric.

6. The system of claim 1, wherein the determining that the cyclic redundancy check passes for the data comprises:
determining that the cyclic redundancy check passes for the data based on satisfaction of a hypothesis of a group of hypotheses usable to test the cyclic redundancy check.

7. The system of claim 1, wherein the determining that the cyclic redundancy check passes for the data comprises:
based on determining that the cyclic redundancy check fails for the data based on a first hypothesis of a group of hypotheses usable to test the cyclic redundancy check, determining that the cyclic redundancy check passes for the data based on satisfaction of a second hypothesis of the group of hypotheses.

8. The system of claim 7, wherein the metric of signal quality is a first metric of signal quality, and wherein the determining that the cyclic redundancy check fails for the data based on the first hypothesis of the group of hypotheses comprises:
determining that a second metric of signal quality that corresponds to the first hypothesis is less than the value specified by the signal quality criterion.

9. The system of claim 1, wherein the cyclic redundancy check is determined to have failed where the cyclic redundancy check fails with each hypothesis of a group of hypotheses usable to test the cyclic redundancy check.

10. A method, comprising:
determining, by a system comprising at least one processor, that a cyclic redundancy check passes for data received on a channel established via a broadband cellular communications network;
based on the determining that the cyclic redundancy check passes for the data, decoding, by the system, a payload of the data to produce a transmitted signal;
determining, by the system, a metric of signal quality for the channel based on reference symbols of the transmitted signal, and at least some data symbols reconstructed from a data payload of the transmitted signal that passes for the cyclic redundancy check;
evaluating, by the system, the metric of signal quality with respect to a signal quality criterion, to produce a signal quality evaluation result; and
where the signal quality evaluation result indicates that the metric of signal quality is less than the signal quality criterion, classifying, by the system, the data as a discontinuous transmission.

11. The method of claim 10, further comprising:
where the signal quality evaluation result indicates that the metric of signal quality is less than the signal quality criterion, disregarding, by the system, that the cyclic redundancy check passes for the data.

12. The method of claim 10, further comprising:
where the signal quality evaluation result indicates that the metric of signal quality is greater than or equal to the signal quality criterion, determining, by the system, that the data is valid.

13. The method of claim 10, wherein determining the metric of signal quality for the channel is based on at least a portion of the transmitted signal that is separate from a demodulation reference signal.

14. The method of claim 10, wherein the cyclic redundancy check comprises error-detecting data for the data.

15. A non-transitory computer-readable medium comprising instructions that, in response to execution, cause a system comprising at least one processor to perform operations, comprising:
based on an error-detection code passing for data received on a channel of broadband cellular communications, decoding a payload of the data to produce a transmitted signal;
determining a metric of signal quality for the channel based on at least a portion of a data payload of the transmitted signal;
comparing the metric of signal quality to a threshold value determined with reference to a signal quality criterion, to produce a signal quality result; and
in response to the signal quality result indicating that the metric of signal quality is greater than or equal to the threshold value, determining that the data is valid.

16. The non-transitory computer-readable medium of claim 15, wherein the operations further comprise:
in response to the signal quality result indicating that the metric of signal quality is less than the threshold value, classifying the data as a discontinuous transmission.

17. The non-transitory computer-readable medium of claim 15, wherein the operations further comprise:
in response to the signal quality result indicating that the metric of signal quality is less than the threshold value, determining that the error-detection code passing was mis-detected.

18. The non-transitory computer-readable medium of claim 15, wherein the system comprises a base station that facilitates the broadband cellular communications.

19. The non-transitory computer-readable medium of claim 15, wherein the signal quality criterion is specified as a function of a scheduling configuration.

20. The non-transitory computer-readable medium of claim 19, wherein the scheduling configuration specifies a number of resource blocks or a number of demodulation reference signals, and wherein the signal quality criterion is specified as a function of the number of resource blocks or a number of demodulation reference signals.
